(19) United States
(12) Patent Application Publication
(10) Pub. No.: US 2015/0305387 A1
(43) Pub. Date: Oct. 29, 2015

(54) NUTRITIONAL COMPOSITION WITH NON DIGESTIBLE OLIGOSACCHARIDES

(71) Applicant: N.V. NUTRICIA, Zoetermeer (NL)

(72) Inventors: Sylvie HUYBERS, Utrecht (NL); Thomas LUDWIG, Utrecht (NL); Houkje BOURITIUS, Utrecht (NL)

(73) Assignee: N.V. NUTRICIA, Zoetermeer (NL)

(21) Appl. No.: 14/650,714

(22) PCT Filed: Dec. 10, 2013
(86) PCT No.: PCT/NL2013/050881

§ 371 Date: Jun. 9, 2015

Related U.S. Application Data
(60) Provisional application No. 61/735,129, filed on Dec. 10, 2012.

(30) Foreign Application Priority Data
Dec. 10, 2012 (EP) 12196288.0

(51) Int. Cl. A23L 1/308; A23L 1/29

(52) U.S. Cl. CPC A23L 1/308; A23L 1/296; A23V 2002/00

(57) ABSTRACT

The present invention relates to the use of non digestible oligosaccharides above a certain threshold for improving health of the small intestine, in particular in infants and small children, by increasing the luminal fluid volume and reducing the protease activity or density.

### FIELD OF THE INVENTION

The present invention relates to nutrition for infants, in particular infant formulae, comprising non-digestible oligosaccharides to improve intestinal health in infants or small children, in particular for improving the health of the small intestine.

### BACKGROUND OF THE INVENTION

Breast-feeding is the preferred method of feeding infants. However, there are circumstances that make breast-feeding impossible or less desirable. In those cases infant formulae are a good alternative. The composition of modern infant formulae is adapted in such a way that it meets many of the special nutritional requirements of the fast growing and developing infant. Still further improvements can be made.

Human milk comprises non-digestible oligosaccharides which represent, after lactose and lipids, the third largest fraction, of which the concentration, dependent on the Lewis blood group of the mother and the stage of lactation, can range from about 7.5 to 15 g/liter for mature human milk.

The human milk oligosaccharides remain undigested in the small intestine and enter the colon where they stimulate the formation of a microbiota rich in Bifidobacteria and influence the physiology of the colon, such as the formation of organic acids, the formation of mucins, decreasing the pH, and effecting the barrier function.

Infant formulae with non-digestible oligosaccharides, in particular a mixture of short chain galacto-oligosaccharides and long chain fructo-oligosaccharides in a 9 to 1 weight ratio, are known to beneficially effect the colonic microbiota, formation of mucin the physiology of the colon and the immune system, including effects against food allergy and atopic dermatitis.

However, little is known on the direct effect of such non-digestible oligosaccharides on the physiology of the small intestine and the health effects resulting thereof. Especially in young infants having an immature small intestine, if such effects are found, theses may be very relevant.

EP2219672 discloses the use of galacto-oligosaccharides and polyfructose for the increase of the intestinal barrier functioning and/or mucus production of the large intetstine.

EP1815755 discloses the use of long and short chain oligosaccharides for stimulating the mucus production in different parts of the ileum and the colon.

WO 2010/008278 discloses the use of probiotic bacteria and preferably dietary fibers in patients with a motility disorder to treat Pseudomonas aeruginosa infection, and small bowel overgrowth. Barnes et al, 2012, JPEN, 36 :524-37 discloses that treatment with short chain fructo-oligosaccharide increased ileal mucosa weight, protein and villus height in piglets. However, Shim et al, 2005, Acta Agriculturae Scandinavica, 55 :91-97 found no such effects on villus height in the small intestine when two different fructo-oligosaccharides concentrations were tested in piglets. In Houdijk et al, 1999, J Animal Sci. 77 :148-158 the effect of a long term diet with non digestible oligosaccharides on apparent ileal and total tract nutrient digestion by pigs was disclosed.

### SUMMARY OF THE INVENTION

Employing an animal model with canulated piglets, the inventors found that the presence of non-digestible oligosaccharides (NDO) in the nutritional composition at a concentration of at least 2 wt. % based on dry weight of the nutritional composition and/or at least 0.4 g based on 100 ml of the nutritional composition increased the volume of the luminal fluid inside the small intestine. Below this concentration, such effect was not observed. It was found to be a direct effect of the NDO, since the role of microbiota or short chain fatty acids (SCFA) indicated by a change in pH, was found to be absent. It was also found to be an acute effect and not an effect on the development of the intestine such as increasing the villus height, or ileal mucosa tissue, as the piglets were exposed to the nutritional composition only for one day.

This effect of non digestible oligosaccharides on the small intestine beneficially mimics the situation in breast fed infants and has an advantageous effect of the small intestinal health by diluting toxins, pathogenic micro-organisms and protease activity (e.g. trypsin, chymotrypsin and elastase activity).

Exposure of the small intestine to toxic compounds, pathogens or endogenous proteases (such as digestive proteases) can result in epithelial damage, infections, or increased pain perception and/or impaired barrier function via the activation of PAR2 receptors. This can have a negative effect on gastrointestinal health and the incidence of infections and inflammation. Hence beneficial effects on intestinal health comfort will occur, especially in young infants, since their small intestine is not yet fully developed, when non-digestible oligosaccharides are administered above the threshold concentration.

### DETAILED DESCRIPTION OF THE INVENTION

The present invention thus concerns a method for increasing the luminal fluid volume inside the small intestine of a subject, comprising administering to the subject a nutritional composition, which is not human milk, comprising protein, digestible carbohydrates, fat and non-digestible oligosaccharide selected from one or more of the group consisting of fructo-oligosaccharides, galacto-oligosaccharides, gluco-oligosaccharides, arabino-oligosaccharides, mannan-oligosaccharides, xylo-oligosaccharides, fuco-oligosaccharides, arabinogalacto-oligosaccharides, glucomanno-oligosaccharides, galactomanno-oligosaccharides, sialic acid comprising oligosaccharides and uronic acid oligosaccharides, wherein the non-digestible oligosaccharide is present in an amount of at least 2 wt. % based on dry weight of the nutritional composition and/or at least 0.4 g based on 100 ml of the nutritional composition.

In one embodiment the method for increasing the luminal fluid volume inside the small intestine of a subject is a non-medical method.

In other words the invention concerns the use of non-digestible oligosaccharides, or a composition comprising non-digestible oligosaccharides, for the manufacture of a nutritional composition, for increasing, or for use in increasing, the luminal fluid volume inside the small intestine of a subject, wherein the non-digestible oligosaccharide is selected from one or more of the group consisting of fructo-oligosaccharides, galacto-oligosaccharides, gluco-oligosaccharides, arabino-oligosaccharides, mannan-oligosaccharides, xylo-oligosaccharides, fuco-oligosaccharides, arabinogalacto-oligosaccharides, glucomanno-oligosaccharides, galactomanno-oligosaccharides, sialic acid comprising oligosaccharides and uronic acid oligosaccharides and wherein the non-digestible oligosaccharide is present in an amount of at least 2 wt. % based on dry weight of the nutritional composition and/or at least 0.4 g based on 100 ml of the nutritional composition and wherein the nutritional composition is not human milk.

The invention can also be worded as a nutritional composition, which is not human milk, comprising protein, digestible carbohydrates, fat and non-digestible oligosaccharide selected from one or more of the group consisting of fructo-oligosaccharides, galacto-oligosaccharides, gluco-oligosaccharides, arabino-oligosaccharides, mannan-oligosaccharides, xylo-oligosaccharides, fuco-oligosaccharides, arabinogalacto-oligosaccharides, glucomanno-oligosaccharides, galactomanno-oligosaccharides, sialic acid comprising oligosaccharides and uronic acid oligosaccharides, wherein the non-digestible oligosaccharide is present in an amount of at least 2 wt. % based on dry weight of the nutritional composition and/or at least 0.4 g based on 100 ml of the nutritional composition for use in increasing the luminal fluid volume inside the small intestine of a subject.

The present invention also concerns a method for decreasing luminal protease activity or density in the intestine of a subject, for treating and/or preventing small bowel bacterial overgrowth in a subject, for increasing gastro-intestinal transit time in a subject and/or for decreasing the activity of toxins in the intestine of a subject, comprising administering to the subject a nutritional composition, which is not human milk, comprising protein, digestible carbohydrates, fat and non-digestible oligosaccharide selected from one or more of the group consisting of fructo-oligosaccharides, galacto-oligosaccharides, gluco-oligosaccharides, arabino-oligosaccharides, mannan-oligosaccharides, xylo-oligosaccharides, fuco-oligosaccharides, arabinogalacto-oligosaccharides, glucomanno-oligosaccharides, galactomanno-oligosaccharides, sialic acid comprising oligosaccharides and uronic acid oligosaccharides, wherein the non-digestible oligosaccharide is present in an amount of at least 2 wt. % based on dry weight of the nutritional composition and/or at least 0.4 g based on 100 ml of the nutritional composition.

In one embodiment the method for decreasing luminal protease activity or density in the intestine of a subject, the method for treating and/or preventing small bowel bacterial overgrowth in a subject, the method for use in increasing gastro-intestinal transit time in a subject and/or the method for decreasing the activity of toxins in the intestine of a subject is a non-medical method. In one embodiment the method for decreasing luminal protease activity or density in the intestine of a subject and/or the method for use in increasing gastro-intestinal transit time in a subject is a non-medical method.

In other words the invention concerns the use of non-digestible oligosaccharides, or a composition comprising non-digestible oligosaccharides, for the manufacture of a nutritional composition, for decreasing luminal protease activity or density in the intestine of a subject, for treating and/or preventing small bowel bacterial overgrowth in a subject, for increasing gastro-intestinal transit time in a subject and/or for decreasing the activity of toxins in the intestine of a subject, wherein the non-digestible oligosaccharide is selected from one or more of the group consisting of fructo-oligosaccharides, galacto-oligosaccharides, gluco-oligosaccharides, arabino-oligosaccharides, mannan-oligosaccharides, xylo-oligosaccharides, fuco-oligosaccharides, arabinogalacto-oligosaccharides, glucomanno-oligosaccharides, galactomanno-oligosaccharides, sialic acid comprising oligosaccharides and uronic acid oligosaccharides and wherein the non-digestible oligosaccharide is present in an amount of at least 2 wt. % based on dry weight of the nutritional composition and/or at least 0.4 g based on 100 ml of the nutritional composition and wherein the nutritional composition is not human milk.

The invention can also be worded as a nutritional composition, which is not human milk, comprising protein, digestible carbohydrates, fat and non-digestible oligosaccharide selected from one or more of the group consisting of fructo-oligosaccharides, galacto-oligosaccharides, gluco-oligosaccharides, arabino-oligosaccharides, mannan-oligosaccharides, xylo-oligosaccharides, fuco-oligosaccharides, arabinogalacto-oligosaccharides, glucomanno-oligosaccharides, galactomanno-oligosaccharides, sialic acid comprising oligosaccharides and uronic acid oligosaccharides, wherein the non-digestible oligosaccharide is present in an amount of at least 2 wt. % based on dry weight of the nutritional composition and/or at least 0.4 g based on 100 ml of the nutritional composition for use in decreasing luminal protease activity or density in the intestine of a subject, for use in treating and/or preventing small bowel bacterial overgrowth in a subject, for use in increasing gastro-intestinal transit time in a subject and/or for use in decreasing the activity of toxins in the intestine of a subject.

In one embodiment, the use according to the present invention or the nutritional composition for use according to the present invention is for treating and/or preventing small bowel bacterial overgrowth in a subject and/or for decreasing the activity of toxins in the intestine of a subject.

According to the present invention, preferably the subject is a human subject.

Wherever in this document the phrase “nutritional composition” or “present nutritional composition” is used, it is to be understood that this refers to the use of the nutritional composition according to the present or to the method of according to the present invention.

Non-Digestible Oligosaccharides

The present nutritional composition comprises non-digestible oligosaccharide (NDO). The term “oligosaccharide” as used in the present invention preferably refers to a saccharide with a degree of polymerization (DP) of 2 to 250, preferably a DP of 2 to 100, more preferably of 2 to 60. It is understood that in the context of this invention a saccharide with a DP in a certain range may include a mixture of saccharides with different average DP's, for example, if an oligosaccharide with a DP of 2 to 100 is included in the present nutritional composition, this may include nutritional compositions which contain oligosaccharides with an average DP between 2 and 5, an average DP between 50 and 70 and an average DP between 7 and 60. The term “non-digestible oligosaccharide” as used in the present invention refers to oligosaccharides which are not or only partially digested in the intestine by the action of acids or digestive enzymes present in the human upper digestive tract (small intestine and stomach) but which are fermented by the human intestinal microbiota. For example, sucrose, lactose, maltose and maltodextrins are considered digestible. For example, galacto-oligosaccharides, fructo-oligosaccharides are considered non-digestible oligosaccharide.

The non-digestible oligosaccharide is selected from the group consisting of fructo-oligosaccharides (such as inulin), galacto-oligosaccharides (such as transgalacto-oligosaccharides or beta-galacto-oligosaccharides), gluco-oligosaccharides (such as gentio-, nigero- and cyclodextrin-oligosaccharides), arabino-oligosaccharides, mannan-oligosaccharides, xylo-oligosaccharides, fuco-oligosaccharides, arabinogalacto-oligosaccharides, glucomanno-oligosaccharides, galactomanno-oligosaccharides, sialic acid comprising oligosaccharides and uronic acid oligosaccharides. In one embodiment of the method or use or nutritional composition for use according to the present invention, the non-digestible oligosaccharide in the nutritional composition comprises galacto-oligosaccharide.

Preferably the present nutritional composition comprises fructo-oligosaccharide and/or galacto-oligosaccharide, more preferably galacto-oligosaccharide, most preferably betagalacto-oligosaccharide. In a preferred embodiment the nutritional composition comprises a mixture of galacto-oligosaccharides and fructo-oligosaccharides, more preferably betagalacto-oligosaccharides and fructo-oligosaccharides. In one embodiment of the method or use or nutritional composition for use according to the present invention, the non-digestible oligosaccharide in the nutritional composition comprises a mixture of galacto-oligosaccharides and fructo-oligosaccharides. In one embodiment of the method or use or nutritional composition for use according to the present invention, the non-digestible oligosaccharide in the nutritional composition is a mixture of galacto-oligosaccharides and fructo-oligosaccharides. Preferably the present nutritional composition comprises galacto-oligosaccharides with a DP of 2-10, preferably with an average DP between 2 and 10, and/or fructo-oligosaccharides with a DP of 2-60, preferably with an average DP between 2 and 60, preferably with an average DP between 10 and 60, preferably with an average DP between 20 and 60. In one embodiment the present nutritional composition comprises galacto-oligosaccharides with a DP of 2-10, preferably with an average DP between 2 and 10, and/or fructo-oligosaccharides with a DP of 2-10, preferably with an average DP between 2 and 10. Preferably the nutritional composition comprises galacto-oligosaccharide and fructo-oligosaccharide in a weight ratio of 20 to 0.5, more preferably 20 to 1, more preferably 10 to 1, most preferably from 12 to 2.

The galacto-oligosaccharide is preferably selected from the group consisting of transgalacto-oligosaccharides, lacto-N-tetraose (LNT), lacto-N-neotetraose (neo-LNT), fucosyl-lactose, fucosylated LNT and fucosylated neo-LNT. In a particularly preferred embodiment the present method comprises the administration of transgalacto-oligosaccharides ([galactose]ₙ-glucose; wherein n is an integer between 1 and 60, i.e. 2, 3, 4, 5, 6, . . . , 59, 60; preferably n is selected from 2, 3, 4, 5, 6, 7, 8, 9, or 10). Transgalacto-oligosaccharides (TOS) are for example sold under the trademark Vivinal™ (Borculo Domo Ingredients, Netherlands). Preferably the saccharides of the transgalacto-oligosaccharides are β-linked. The β-linkages between the monosaccharide moieties in the oligosaccharides preferably are β-1,4 or β-1,6 or β-1,3. according to any one of the preceding claims wherein the non-digestible oligosaccharides comprise galacto-oligosaccharides with beta-1,3, beta-1,4 and/or beta-1,6 linkages. In one embodiment of the method or use or nutritional composition for use according to the present invention, the non-digestible oligosaccharides comprise galacto-oligosaccharide with beta-1,3, beta-1,4 and/or beta-1,6 linkages.

In one embodiment the present nutritional composition preferably contains fructooligosaccharide. The term “fructo-oligosaccharide” as used herein refers to a non-digestible polysaccharide comprising a chain of at least 2β-linked fructose units, with a DP of 2 to 250, preferably 7 to 100, more preferably 20 to 60. In one embodiment preferably inulin is used. Inulin is for example available under the tradename “Raftilin HP®”, (Orafti). The average DP of the present fructo-oligosaccharide is preferably at least 7, more preferably at least 10, preferably below 100. The fructo-oligosaccharide used preferably has the (majority of) fructose units linked with a β(2→1) linkage. Other terms for fructooligosaccharides include inulin, fructopolysaccharide, polyfructose, fructans and oligofructose. The present nutritional composition preferably comprises fructo-oligosaccharides with a DP of 2 to 200. In one embodiment the present nutritional composition preferably comprises 2 different fractions of fructo-oligosaccharides, one fraction with an average DP between 2 and 20 and a second fraction with an average DP between 20 and 60, or one fraction with an average DP between 2 and 10 and a second fraction with an average DP between 10 and 60.

The nutritional composition comprises at least 0.4 g non-digestible oligosaccharide per 100 ml and/or at least 2 wt. % based on dry weight. Preferably, the nutritional composition comprises 0.4 g to 4.0 g non-digestible oligosaccharide per 100 ml, more preferably 0.6 to 2.5 g, even more preferably 0.7 g to 1.5 g per 100 ml. Based on dry weight, the nutritional composition preferably comprises 2 wt. % to 20 wt. %, more preferably 3 wt. % to 12 wt. %, even more preferably 4 wt. % to 7.5 wt. % non-digestible oligosaccharide. If lower concentrations of non-digestible oligosaccharide is used, less or no effect on the small intestine will be observed.

Preferably the nutritional composition does not comprise living (i.e. replicating) lactic acid producing bacteria selected from the group consisting of Lactobacilli and Bifidobacteria, since they consume the non-digestible oligosaccharides and therefore reduce the concentration to below threshold value.

Nutritional Compositions

The present invention advantageously concerns a nutritional composition, in particular the use thereof as defined herein, wherein the lipid provides 5 to 50% of the total calories, the protein provides 5 to 50% of the total calories, and the carbohydrate provides 15 to 90% of the total calories. Preferably, in the present nutritional composition the lipid provides 35 to 50% of the total calories, the protein provides 7.5 to 12.5% of the total calories, and the carbohydrate provides 40 to 55% of the total calories. For calculation of the % of total calories for the protein component, the total of energy provided by the proteins, peptides and amino acids needs to be taken into account.

The present nutritional composition preferably comprises at least one lipid selected from the group consisting of animal lipid (excluding human lipids) and vegetable lipids. Preferably the present nutritional composition comprises a combination of vegetable lipids and at least one oil selected from the group consisting of fish oil, animal oil, algae oil, fungal oil, and bacterial oil. The present nutritional composition comprising non-digestible oligosaccharides excludes human milk.

The present nutritional composition preferably comprises protein. The protein component used in the nutritional composition is preferably selected from the group consisting of non-human animal proteins (preferably milk proteins, preferably proteins from cow's milk), vegetable proteins (preferably soy protein and/or rice protein), free amino acids and mixtures thereof. The present nutritional composition preferably contains casein, whey, hydrolysed casein and/or hydrolysed whey protein. Preferably the protein comprises intact proteins, more preferably intact bovine whey proteins and/or intact bovine casein proteins.

The present nutritional composition preferably comprises digestible carbohydrates. The present nutritional composition preferably comprises a digestible carbohydrate component, wherein at least 35 wt. %, more preferably at least 50 wt. %, more preferably at least 75 wt. %, even more preferably at least 90 wt. %, most preferably at least 95 wt. % is lactose. The present nutritional composition preferably comprises at least 25 grams lactose per 100 gram dry weight of the present nutritional composition, preferably at least 40 grams lactose/100 gram.

The liquid nutritional composition preferably has a caloric density between 0.1 and 2.5 kcal/ml, even more preferably a caloric density of between 0.5 and 1.5 kcal/ml, most preferably between 0.6 and 0.8 kcal/ml. The amount of nutritional composition administered per day is preferably between 50 and 2000 ml, more preferably between 200 and 1500, most preferably between 400 and 1000 ml.

Preferably the nutritional composition has an osmolality below 500 mOsmol/kg, more preferably below 450. Preferably the osmolality is above 150. A too high osmolality or too low osmolality will disadvantageously effect the volume of the fluid in the lumen inside the small intestine.

Application

The present nutritional composition for the present method or use is specifically intended for human subjects, preferably for infants and/or toddlers. Infants have an age of 0-12 months, toddlers have an age of 12-36 months. More preferably it is intended for infants with an age of 0 to 6 months. In such young subjects the small intestine is immature and under development. Therefore the present beneficial effects on the small intestine health are especially important in this target group. In one embodiment of the method or use or nutritional composition for use according to the present invention, the nutritional composition is for providing nutrition to infants and/or toddlers.

The present nutritional composition is preferably enterally administered, more preferably orally. The present nutritional composition can advantageously be applied as a complete nutrition for infants. The present nutritional composition preferably comprises lipid, protein, and carbohydrate and is preferably administered in liquid form. The present nutritional composition is preferably a nutritional formula, preferably an infant formula or follow on formula. International directives are known regarding the composition of such infant formula or follow on formula. The present invention includes dry nutritional compositions, e.g. powders, which are accompanied with instructions as to admix said dry compositions, in particular nutritional formula, with a suitable liquid, e.g. water. Thus in one embodiment of the method or use or nutritional composition for use according to the present invention, the nutritional composition is in liquid form or in the form of a powder suitable to be reconstituted to a with water.

Employing an animal model with canulated piglets, the inventors found that the presence of non-digestible oligosaccharides (NDO) in the nutritional composition at a concentration of at least 2 wt. % based on dry weight of the nutritional composition and/or at least 0.4 g based on 100 ml of the nutritional composition increased the volume of the luminal fluid inside the small intestine. Below this concentration, such effect was not observed. It was found to be a direct effect of the NDO, since the role of microbiota or SCFA indicated by a change in pH, was absent. It was also found to be an acute effects and not an effect on the development of the intestine such as increasing the villus height, or ileal mucosa tissue, as the piglets were exposed to the nutritional compositions only for one day.

This effect of non digestible oligosaccharides on the small intestine beneficially mimics the situation in breast fed infants and has an advantageous effect of the small intestinal health by diluting toxins, pathogenic micro-organisms and protease activity (e.g. trypsin, chymotrypsin and elastase activity).

Exposure of the small intestine to toxic compounds, pathogens or endogenous proteases (such as digestive proteases) can result in epithelial damage, infections, or increased pain perception and/or impaired barrier function via the activation of PAR2 receptors. This can have a negative effect on gastrointestinal health and the incidence of infections and inflammation. Hence beneficial effects on intestinal health comfort, preferably small intestinal health, will occur, especially in young infants, since their small intestine is not yet fully developed, when non-digestible oligosaccharides are administered above the threshold concentration.

So the present nutritional compositions is preferably for use in increasing the luminal fluid volume inside the small intestine of a subject. With this effect intestinal health is improved, so in a preferred embodiment, the nutritional compositions is for use in improving intestinal health. Increasing the luminal fluid volume inside the small intestine of a subject has the further advantage that luminal protease activity or density in the intestine can be decreased, that small bowel bacterial overgrowth can be prevented, that gastro-intestinal transit time can be increased, and/or that the activity of toxins in the intestine can be decreased. So in one embodiment, the present nutritional compositions is preferably for use in decreasing luminal protease activity or density in the intestine of the subject, for use in treating and/or preventing small bowel bacterial overgrowth in the subject, for use in increasing gastro-intestinal transit time in the subject and/or for use in decreasing the activity of toxins in the intestine of the subject.

In one embodiment, the use in increasing the luminal fluid volume inside the small intestine of a subject is a non-medical use. In a preferred embodiment the non-medical use, or non medical method according to the invention, is for decreasing luminal protease activity or density in the intestine of the subject and/or for increasing gastro-intestinal transit time in the subject.

### EXAMPLES

### Example 1

### Infant Formula with Non Digestible Oligosaccharides Increases Intestinal Volume in Piglets

Eighteen age- and weight-matched (Piétrain X (Large white X Landrace)) male piglets (mean BW 5.1±0.03 kg) were selected 14 days after birth from 8 different litters. The piglets were individually housed in a temperature-controlled room maintained at 28° C. At day 26 the piglets were operated on to receive a T-cannula at the distal end of the terminal ileum after overnight fasting. The piglets were allowed to recover for 7 days before the start of the experiment. Six diets were tested in the piglets. The diets were dissolved in demineralized water (37° C.) with a final dry matter content of 20% (w/v).

Diet 1 was an infant formula comprising short chain trans-galacto-oligosaccharides GOS2 (beta linked, mainly beta 1,3 linked) in a concentration of 1.0 wt % based on dry weight of the total composition and 0.2 g per 100 ml. The osmolality of the formula was 453±2.4 mOsm/kg.

Diet 2 was a infant formula without non-digestible oligosaccharides. The osmolality of the formula was 421±23.1 mOsm/kg.

Diet 3 was an infant formula comprising non-digestible oligosaccharides in a concentration of 5.7 wt % based on dry weight of the total composition and 1.14 g per 100 ml, in form of a mixture of 9:1 wt/wt short chain transgalacto-oligosaccharide GOS1 (source Vivinal GOS, FrieslandCampina DOMO, beta linked, which has mainly beta 1,4 and beta 1,6 linkages) and long chain fructo-oligosaccharides (RaftilinHP, Orafti). The osmolality of the formula was 467±4.3 mOsm/kg.

Diet 4 was an infant formula comprising the same non-digestible oligosaccharides as in diet 1, but at a concentration of 0.5 wt % based on dry weight of the total composition and 0.1 g per 100 ml. The osmolality of the formula was 427±1.5 mOsm/kg.

Diet 5 was an infant formula comprising non-digestible oligosaccharides of diet 3 and 4, at a total concentration of 6.2 wt % based on dry weight of the total composition and 1.24 g per 100 ml. The osmolality of the formula was 481±3.6 mOsm/kg.

The osmolality of the diets was not significantly different. It should be noted that due to the EU directives the non-digestible disaccharides in the GOS1 or GOS2 do not qualify as dietary fiber. Hence the fiber content on an infant formula may be labeled lower.

For further details see Table 1.

From birth until day 14 the piglets remained with the sow and received sow's milk only. From day 14 until the start of the cannula experiment (day 33), the piglets received a mixture of the diets ad-libitum via an automatic computer-controlled feeding system. For proper growth, the piglets started with 8 feedings a day after which the number of meals was progressively decreased to 4 meals a day from day 21 onwards at 7.00 am, 10.00 am, 13.00 pm and 16.00 pm. During the cannula experiment (day 33 to 44), twelve piglets received the individual diets for 2 days according to a Latin Square design at 7.00 am, 10.00 am, 13.00 pm and 16.00 pm. The piglets received 1400 kJ per kg body weight (metabolic weight). Piglets were weighed before changing diets at day 33, 35, 37, 39, 41 and 43. Chromium oxide (0.25 g/kg) was added to the IF powder as an indigestible, internal standard to measure the amount of digesta flowed into the ileal collection bags.

TABEL 1
Composition of the tested diets

| Diet (all 20 g dry weight/100 ml) | 1 | 2 | 3 | 4 | 5 |
|---|---|---|---|---|---|
| Energy (Kcal/100 g) | 460 | 473 | 451 | 450 | 428 |
| Protein (g/100 g) | 7.8 | 7.9 | 8.0 | 8.4 | 8.4 |
| Casein:whey wt/wt | 60:40 | 60:40 | 60:40 | 60:40 | 60:40 |
| Digestible carbohydrates (g/100 g) | 71 | 69 | 64 | 65 | 60 |
| Lactose | 31 | 32 | 34 | 32 | 33 |
| Maltodextrin | 39 | 38 | 19 | 38 | 20 |
| Fat (g/100 g) | 15.9 | 18.2 | 18.2 | 17.3 | 17.3 |
| NDO (g/100 g) % wt/dry wt. | 1.0 | 0.0 | 5.7 | 0.5 | 6.2 |
| GOS/FOS (9:1) % wt/dry wt. | 0.0 | 0.0 | 5.7 | 0.0 | 5.7 |
| TOS % wt/dry wt. | 1.0 | 0.0 | 0.0 | 0.5 | 0.5 |

During the T-cannula experiment, ileal digesta was continuously collected from each individual diet at day 34, 36, 38, 40, 42 and 44 from 9.00 to 17.00 h. The digesta was collected 2-hourly in small bags that were emptied immediately when filled and stored on ice. All samples were stored at −80° C. until further processing.

Dry matter (DM) (gravimetry at 80° C.), chromium oxide (Cr) (inductively coupled plasma mass spectrometry), and crude protein (CP) (Kjeldahl method, N×6.25) were analyzed in freeze-dried digesta samples and diet powders.

Total proteolytic activity in the ileal digesta was determined using the EnzCheck protease 25 fluorescence based assay kit (E6638, Invitrogen, Carlsbad, Calif., USA) for detecting metallo-, serine and sulfhydryl proteases. Porcine pancreatin (Sigma, P1750) was used to prepare a calibration curve. Activity is expressed as arbitrary unit (AU) (based on pancreatin activity in USP).

Trypsin activity was measured by using N-Benzoyl-L-Arginne Ethyl Ester (BAEE, Sigma B4500) as substrate and measuring the absorbance change at 25 oC 253 nm (according to the 5 manufacturer's instructions). Bovine trypsin (Sigma, T9201) was used to prepare a calibration curve. Activity is expressed as arbitrary unit (AU) (based on trypsin activity in U).

Chymotrypsin was measured by using N-Benzoyl-L-Tyrosine Ethyl Ester (BTEE, Sigma B6125) as substrate and measuring the absorbance change at 25 oC at 256 nm. Bovine 10 chymotrypsin (Sigma, C3142) was used to prepare a calibration curve. Activity is expressed as arbitrary unit (AU) (based on chymotrypsin activity in U).

Elastase activity was measured by using SucAla3-PNA (S4760, Sigma) as substrate and porcine elastase (E7885, Sigma) was used to prepare a calibration curve. Activity is expressed as arbitrary unit (AU) (based on elastase activity in U).

The results were analyzed using Univariate Analysis of Variance (GLM procedure). Differences between diets were considered significant with p<0.05 according to the LSD test.

The results in Table 2 show that ileal digesta volume is significantly increased after ingesting diet 3 or 5 containing a higher concentration of NDO, when compared with the control diets (diet 2). Strikingly only above a certain threshold amount of NDO this effect was observed, since with diet 1 and 4 no significant difference in intestinal volume was observed compared with diet 2 comprising no NDO.

No effect was observed on the pH of the terminal ileum. This is indicative for the absence of a role of fermentation of the non-digestible oligosaccharides by the intestinal microbiota (located in the colon) and therefore a direct effect of the non-digestible oligosaccharides in the colon. The osmolality was lower in diet 3 and 5 compared to the diet 2 without NDO. The values of diet 1, and 4 were intermediate, but not statistically significantly different from diet 3, 5 and 2. The concentration of proteins was lower, i.e. more diluted, in the digesta of piglets fed a diet 3 and 5 containing NDO when compared to diet 2. Diet 1 showed an intermediate and statistically significant effect in this respect.

Most interestingly, the density of protease activity was lower, i.e. more diluted, in the digesta of piglets fed a diet 3 and 5 containing NDO when compared to diet 2. Diet land 4 showed an intermediate effect, but were not statistically significantly different from the diet without NDO (diet 2) in this respect. Looking at the major digestive enzymes of the intestine chymotrypsin and trypsin, diet 3 and 5 showed a more diluted activity versus diet 2, whereas the diluted activity in diet 1 and 4 was not statistically different from diet 2.

TABLE 2
Ileal digesta characteristics after feeding 5 different diets

| | 1 | 2 | 3 | 4 | 5 |
|---|---|---|---|---|---|
| Digesta volume | 222 ± 22^{a} | 192 ± 16^{a} | 518 ± 56^{b} | 238 ± 26^{a} | 520 ± 45^{b} |
| [g/8 h] | | | | | |
| pH | 7.75 ± 0.08 | 7.79 ± 0.07 | 7.69 ± 0.05 | 7.91 ± 0.06 | 7.79 ± 0.05 |
| Osmolality | 316 ± 4^{ab} | 322 ± 4^{b} | 308 ± 3^{a} | 319 ± 4^{ab} | 308 ± 3^{a} |
| [mOsmol/kg] | | | | | |
| Protein [mg/ml] | 13.8 ± 1.0^{ad} | 16.1 ± 1.2^{b} | 7.2 ± 0.4^{c} | 15.0 ± 1.2^{bd} | 7.3 ± 0.4^{c} |
| Protease [U/ml] | 2553 ± 236^{ab} | 3104 ± 245^{a} | 2095 ± 214^{bc} | 2648 ± 273^{ab} | 1883 ± 165^{c} |
| Trypsin [U/ml] | 3307 ± 125^{a} | 3601 ± 155^{a} | 2514 ± 125^{b} | 3420 ± 145^{a} | 2615 ± 140^{b} |
| Chymotrypsin | 4.7 ± 0.4^{abc} | 5.2 ± 0.4^{bc} | 4.3 ± 0.5^{a} | 5.4 ± 0.4^{c} | 4.2 ± 0.4^{a} |
| [U/ml] | | | | | |
| Elastase [U/ml] | 0.41 ± 0.06^{ac} | 0.47 ± 0.08^{a} | 0.24 ± 0.03^{b} | 0.43 ± 0.06^{ac} | 0.25 ± 0.03^{b} |

Data are expressed as mean ± SEM (N = 18 piglets).
^{(a-d)}Values with different letters within the same row are significantly different (p < 0.05).

### Example 2

An infant formula composition comprising per 100 ml ready to feed formula: 1.6 g protein, 3.6 g fat, 6.4 g digestible carbohydrates (mainly lactose), 0.8 g non-digestible oligosaccharides of which 0.72 g transgalacto-oligosaccharides, 0.08 g inulin. The package and/or supporting material accompanying the product indicates that the product can be suitably used use to decrease luminal protease, or prevents small bowel bacterial overgrowth, or increase gastro-intestinal transit time or decrease the activity of toxins in the intestine.

1-24. (canceled)

25. A method for increasing the luminal fluid volume inside the small intestine of a subject, comprising administering to the subject a nutritional composition, which is not human milk, comprising protein, digestible carbohydrates, fat and one or more non-digestible oligosaccharides selected from of the group consisting of fructo-oligosaccharides, galacto-oligosaccharides, gluco-oligosaccharides, arabino-oligosaccharides, mannan-oligosaccharides, xylo-oligosaccharides, fuco-oligosaccharides, arabinogalacto-oligosaccharides, glucomanno-oligosaccharides, galactomanno-oligosaccharides, sialic acid comprising oligosaccharides and uronic acid oligosaccharides, wherein the non-digestible oligosaccharide is present in an amount of at least 2 wt. % based on dry weight of the nutritional composition and/or at least 0.4 g based on 100 ml of the nutritional composition.

26. The method according to claim 25, for decreasing luminal protease activity or density in the intestine of the subject, for treating and/or preventing small bowel bacterial overgrowth in the subject, for increasing gastro-intestinal transit time in the subject and/or for decreasing the activity of toxins in the intestine of the subject.

27. The method according to claim 25, wherein the non-digestible oligosaccharide is present in an amount of 3 to 12 wt. % based on dry weight of the nutritional composition.

28. The method according to claim 25, wherein the nutritional composition is in liquid form or in the form of a powder suitable to be reconstituted with water.

29. The method according to claim 25, wherein he non-digestible oligosaccharide is present in an amount of from 0.7 to 1.5 g per 100 ml.

30. The method according to claim 25, wherein the non-digestible oligosaccharide comprises galacto-oligosaccharide.

31. The method according to claim 25, wherein the non-digestible oligosaccharides comprise galacto-oligosaccharides with beta-1,3, beta-1,4 and/or beta-1,6 linkages.

32. The method according to claim 25, wherein the non-digestible oligosaccharide comprises a mixture of galacto-oligosaccharides and fructo-oligosaccharides.

33. The method according to claim 25, wherein the nutritional composition does not comprise live lactic acid producing bacteria selected form the group consisting of Lactobacilli and Bifidobacteria.

34. The method according to claim 25, wherein the nutritional composition is an infant or follow on formula.

35. A method of decreasing luminal protease activity or density in the intestine of a subject, for treating and/or preventing small bowel bacterial overgrowth in a subject, for increasing gastro-intestinal transit time in a subject and/or for decreasing the activity of toxins in the intestine of a subject, the method comprising administering to the subject one or more non-digestible oligosaccharides selected from the group consisting of fructo-oligosaccharides, galacto-oligosaccharides, gluco-oligosaccharides, arabino-oligosaccharides, mannan-oligosaccharides, xylo-oligosaccharides, fuco-oligosaccharides, arabinogalacto-oligosaccharides, glucomanno-oligosaccharides, galactomanno-oligosaccharides, sialic acid comprising oligosaccharides and uronic acid oligosaccharides and wherein the non-digestible oligosaccharide is present in an amount of at least 2 wt. % based on dry weight of the nutritional composition and/or at least 0.4 g based on 100 ml of the nutritional composition and wherein the nutritional composition is not human milk.

36. The method according to claim 35, for treating and/or preventing small bowel bacterial overgrowth in a subject and/or for decreasing the activity of toxins in the intestine of a subject.

37. The method according to claim 35, wherein the non-digestible oligosaccharide is present in an amount of 3 to 12 wt. % based on dry weight of the nutritional composition.

38. The method according to claim 35, wherein the nutritional composition is in liquid form or in the form of a powder suitable to be reconstituted with water.

39. The method according to claim 35, wherein he non-digestible oligosaccharide is present in an amount of from 0.7 to 1.5 g per 100 ml.

40. The method according to claim 27, wherein the non-digestible oligosaccharide comprises galacto-oligosaccharide.

41. The method according to claim 35, wherein the non-digestible oligosaccharides comprise galacto-oligosaccharides with beta-1,3, beta-1,4 and/or beta-1,6 linkages.

42. The method according to claim 35, wherein the non-digestible oligosaccharide comprises a mixture of galacto-oligosaccharides and fructo-oligosaccharides.

43. The method according to claim 35, wherein the nutritional composition does not comprise live lactic acid producing bacteria selected form the group consisting of Lactobacilli and Bifidobacteria.

44. The method according to claim 35, wherein the nutritional composition is an infant or follow on formula.
